(19) United States
(12) Patent Application Publication
(10) Pub. No.: US 2013/0282616 A1
(43) Pub. Date: Oct. 24, 2013

(54) Auction Profile Method and System

(71) Applicant: Auction Profile Analytics, LLC, Norfolk, VA (US)

(72) Inventor: Ian M. Grimsley, Norfolk, VA (US)

(21) Appl. No.: 13/865,268

(22) Filed: Apr. 18, 2013

Related U.S. Application Data
(60) Provisional application No. 61/636,167, filed on Apr. 20, 2012.

(51) Int. Cl. G06Q 40/06

(52) U.S. Cl. CPC G06Q 40/06
USPC 705/36 R

(57) ABSTRACT

In one embodiment, the present invention determines and graphically presents balance areas on a price chart for a tradable financial instrument such as a stock, bond, currency, future, etc. By highlighting such areas, the end user may more easily identify possible areas to initiate trades with good trade location according to the present invention. One method according to the present invention provides for receiving input from a user establishing parameters for determining at least one of: a value area, a market condition, and an expiring profile unit; receiving input from a market data component associated with at least one tradable financial instrument; providing a graphical user interface display in the form of a price chart; determining whether one or more profile units are to be displayed as part of the displayed price chart; and based upon the input from the market data component, re-assessing the determination of at least one profile unit to be displayed.

### FIELD OF THE INVENTION

The present invention pertains to investment tools, and more particularly to a system and method for analyzing market data to determine and present information that is usable to discern favorable trade opportunities and/or locations for tradable financial instruments.

### BACKGROUND AND SUMMARY OF THE PRESENT INVENTION

Since the introduction of markets and tradable financial instruments (e.g., stocks, bonds, futures, currencies, etc.), investors have looked for opportunities to gain an “edge” that gives them a greater sense of the probable price direction of a given financial instrument. Fully aware that no system is fool proof and that the market's direction is never predictable with any certainty, investors have realized that market data can be collected, manipulated and analyzed to form reasoned hypotheses about which direction a given tradable instrument's price will take in the future. In many cases, the market data is represented in visual form on a chart. Such approaches are sometimes referred to as technical analysis.

In 1986, J. Peter SteidlMayer introduced a new method of charting market price activity called “Market Profile”, as described, for example, in U.S. Pat. No. 5,454,104. The SteidlMayer approach is used to graphically display market data in a way that allows the end user to see the areas of greater and lesser price activity over time in the form of a vertically-oriented distribution. FIG. 1 illustrates an example of a market profile chart 100.

In essence, the market profile chart 100 is a left justified bar chart, with each of the bars (e.g., 102) represented as a separate letter (e.g., 104) in the graphic. This allows a better visualization of the popularity of each price over the timeframe of the selected bars on the chart. Each individual letter is referred to as a Time/Price Opportunity (TPO). The market profile chart also constructs a “Value Area” 106, which comprises a statistical calculation of the price area that comprises those prices that were traded most frequently during the period of observation. The method specifies the 70% (or any other selected percentage) of TPO's centered around the statistical mode, which is the price with the highest number of TPO's.

Subsequent refinements to the market profile method have substituted the original method of using TPO's as the elemental unit with the actual volume of transactions that occurred at each price during the period of observation.

Traditionally, the market profile chart provided a left-justified representation of each thirty-minute period during the trading day to create a Day profile. Subsequently, trading software has offered the ability to specify any arbitrary start and end point for a market profile. For example, one could create a thirty minute profile comprised of its constituent five minute periods, plotting either the TPO's or the analogous trading volume as the elemental units within the graphic, or one could construct an “Overlay Profile” to pinpoint trends and predict market turns, wherein the overlay profile comprises price activity of multiple days rather than a single day. In use, investors/traders may consider, for example, that a stock whose price is currently in the lower range of the market profile may have a greater tendency to rise in price in order to achieve balance.

The market profile system has limitations. Firstly, the purpose of the market profile graphic is to highlight a “Value Area”, an area of “two-sided” trade wherein the market participants generally agree that price is “fair” to both the buyer and seller. The central portion of the graphic, centered around the mode price (also known as the “Point of Control” or “POC”), is said to represent this area of general price agreement. However, the mode does not always capture a market in balance, and thus a perceived market in balance based upon this market value approach may not actually be in balance. For example, it may be in search of a balance. FIGS. 2, 3 and 4 demonstrate and describe this limitation in further detail. In the Market Profile diagram 110 of FIG. 2, for example, a balanced profile is shown in the form of a perfectly Gaussian distribution, wherein the measures of central tendency (mean, midpoint, mode, median) all coincide at 112. However, this diagram can be misleading to an investor. For example, the Market Profile diagram 110 of FIG. 2 may be representative of the actual price distribution represented by the diagram 114 of FIG. 3, but the actual prices in diagram 114 show a value (e.g., elements 116) that is migrating higher over time. Thus, even though the Market Profile diagram 110 of FIG. 2 might represent the distribution of prices from the diagram 114 of FIG. 3, the profile diagram 110 is deceptive, because the market diagram 114 indicates a market in search of a balance as opposed to a market in balance, which is implied by the diagram 110 of FIG. 2. As a further example, the diagram 118 in FIG. 4 shows a market traversing the value area in a back and forth manner. Thus, the fact that the midpoint equals the mean, which equals the mode, which equals the median, does not guarantee that the market is in balance, as suggested by the Market Profile diagram 110 of FIG. 2.

A second limitation of the market profile approach is that it is static: the start and end of the period of market activity depicted in a market profile graphic are arbitrarily determined. For example, a profile may be a “Day Profile”, depicting the market activity during a single day's trading session; or, it may be an hourly profile beginning at the start of each new hour of trading; or it may be a profile covering a specified number of minutes, days, weeks, etc. As a result, the market profile approach is not always a reliable indicator.

The present invention operates differently to overcome the above limitations and more. For example, the method of the present invention is dynamic: market activity itself determines the start and end times of the profile. Additionally, the method of the present invention provides a more robust and accurate assessment of balance by employing the algorithmic processes described herein. In one embodiment, the present invention determines and graphically presents balance areas on a price chart for a tradable financial instrument (e.g., stock, bond, currency, future, etc.). The balance areas can be considered as “areas of price stability”, ‘price congestion” or “horizontal development.” By highlighting such areas, the end user may more easily identify possible areas to initiate trades with good “trade location” according to the present invention.

### BRIEF DESCRIPTION OF THE DRAWINGS

FIG. 1 is a sample chart illustrating the prior art market profile system.

FIGS. 2-4 are diagrams illustrating potential drawbacks associated with the prior art market profile system.

FIGS. 5-8 are diagrams illustrating how swing points (i.e., pivot points), market condition and profile unit elements can be determined in accordance with one embodiment of the present invention.

FIGS. 9A-17 are diagrams illustrating various features and status capabilities for profile units in accordance with embodiments of the present invention.

FIGS. 18-20 are diagrams illustrating the target zone aspect in accordance with embodiments of the present invention.

FIG. 21 is a sample schematic diagram illustrating a system architecture and software components associated with one embodiment of the present invention.

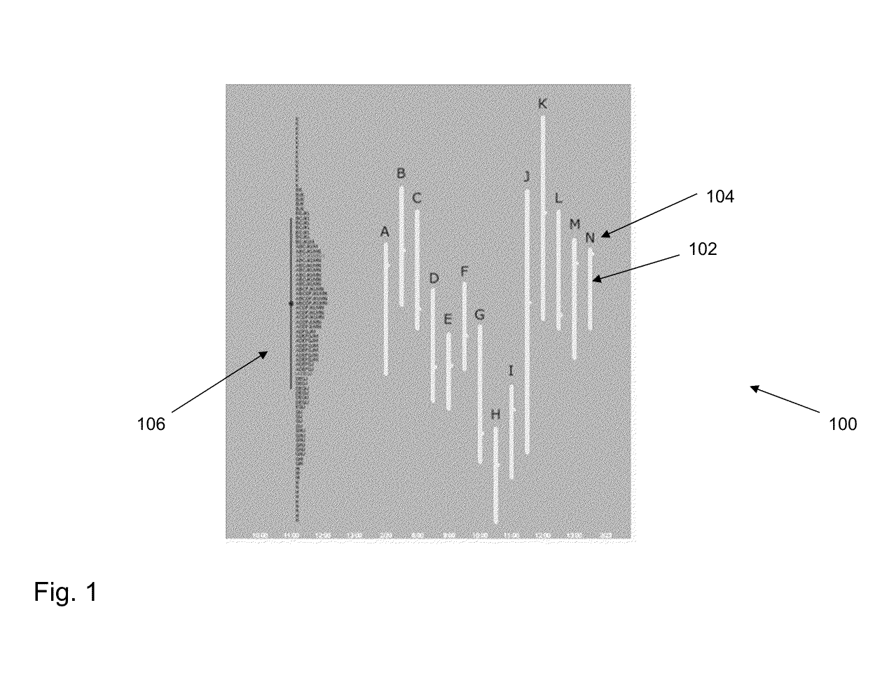

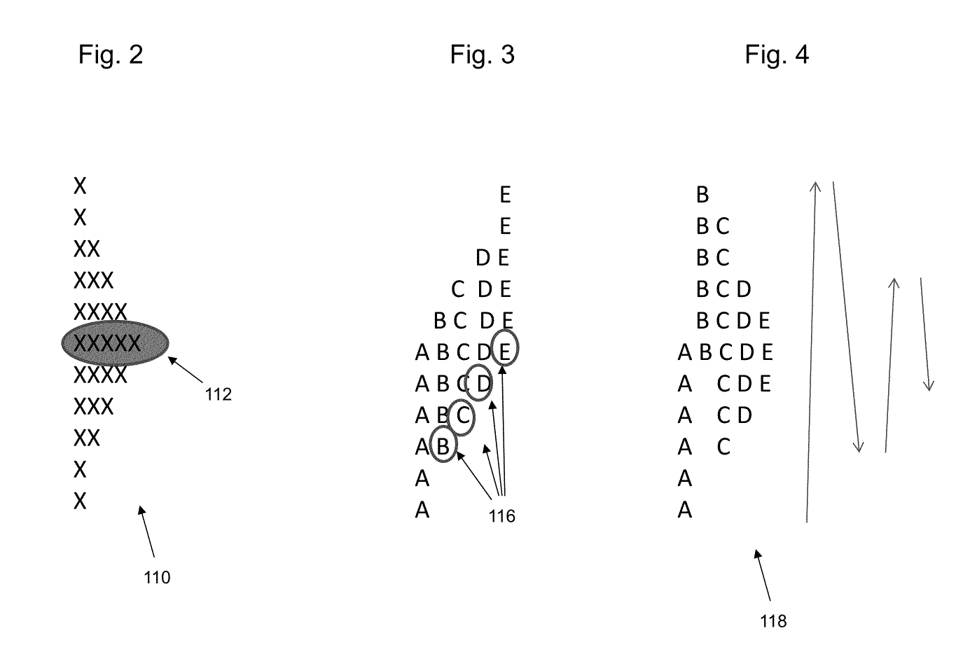

### DETAILED DESCRIPTION OF PREFERRED EMBODIMENTS

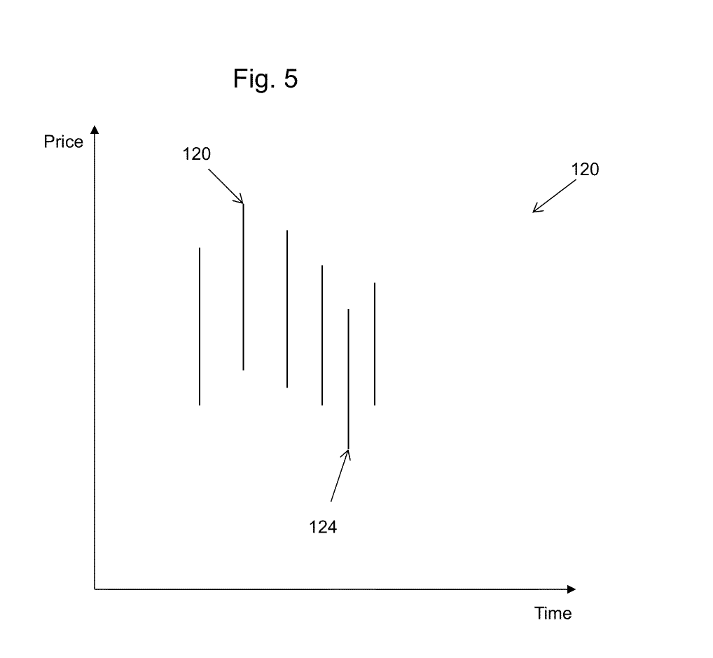

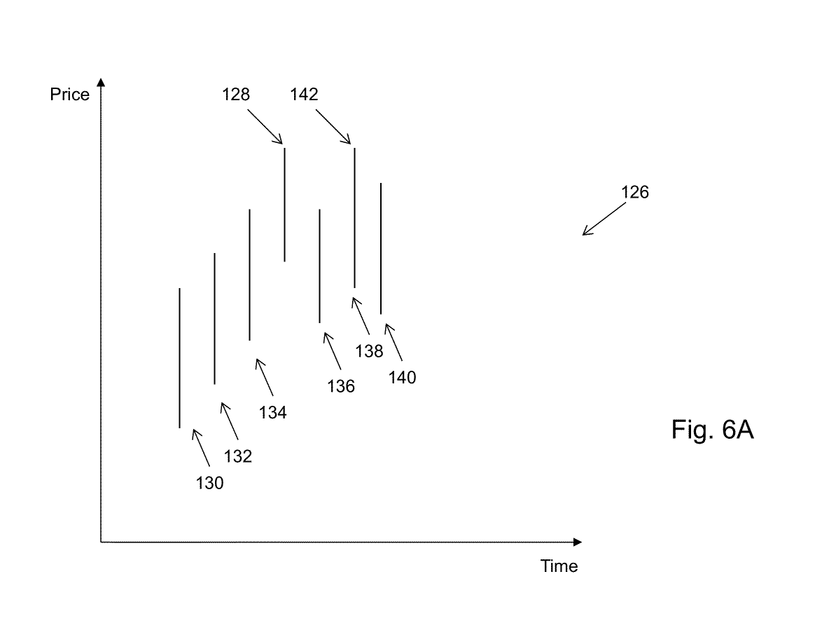

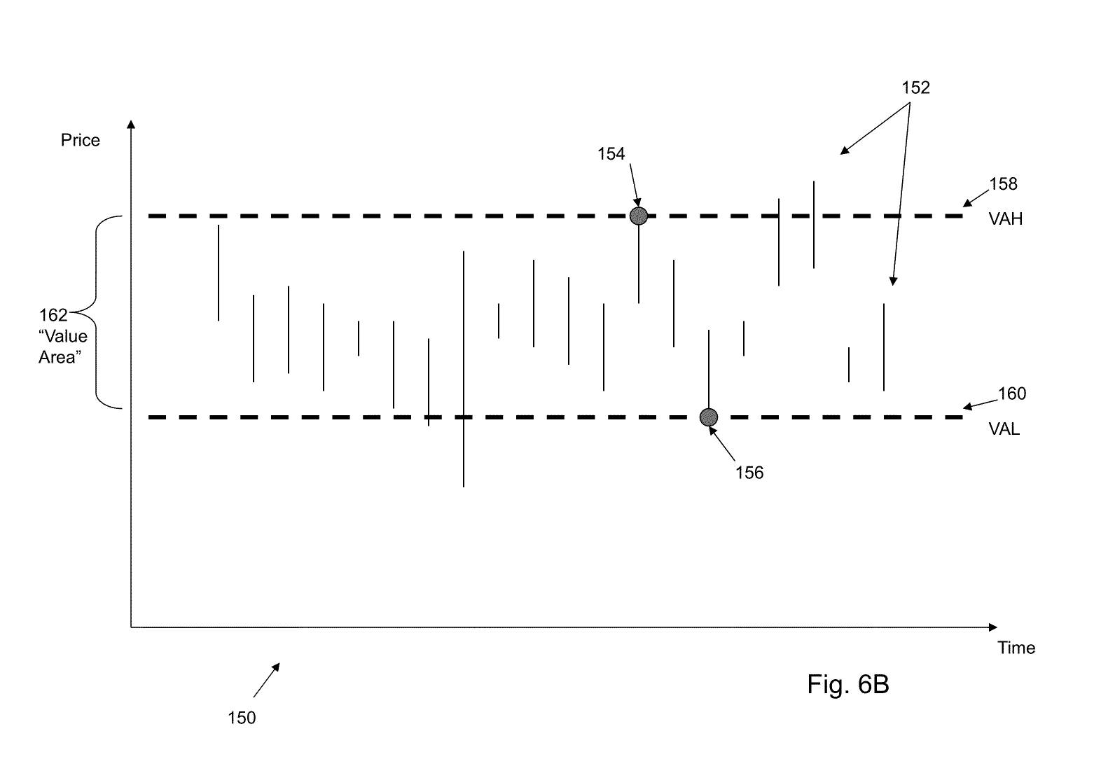

In a representative embodiment, the present invention can facilitate the construction and depiction of dynamic chart profiles for tradable financial instruments in the following manner. First, a new profile unit starts at every pivot point on a price bar chart. A pivot point is a commonly understood term that defines intermediate high and low price points on a chart. A chart or price chart is typically constructed with price on the vertical axis and time on the horizontal axis. A price bar comprises the range of prices that a tradable financial instrument was bought/sold for over a given time interval. Thus, for instance, if a unit of time is five minutes on a chart, and the price of a given financial instrument traded at a price range of $40.50 to $40.75 over a five-minute interval, a vertical bar would appear on the chart representing that range during the given time interval. At its most granular level, a pivot high is a price bar whose high price point is higher than the high of the prior bar and is as high as or higher than the high price point of the succeeding bar. Similarly, a pivot low is a price bar whose low price point is lower than the low price point of the prior bar, and as low as or lower than the low price point of the succeeding bar. These are illustrated in diagram 120 of FIG. 5, where point 122 illustrates a pivot high (or “swing high”) along with the converse pivot low (or “swing low”) point at point 124. In addition to specifying the pivot point, one may specify the “strength” of the pivot by specifying how many prior and subsequent bars must be taken into consideration in determining the validity of the pivot point. This is illustrated and described in diagram 126 of FIG. 6A, where point 128 has a strength of “three” because it has a higher “high” than any point on each of the preceding three bars (130, 132, 134) and a higher or equal high to any point on each of the succeeding three bars (136, 138, 140). Thus, even though point 142 of bar 138 has an equal high to the point 128, point 128 has a strength of three.

A “profile unit” in accordance with the present invention is the distribution of prices over a given number of price bars of any uniform duration. The starting point of a profile unit is a pivot point, which is either a Pivot High or a Pivot Low of a user-determined “strength”. The end point of a profile unit is either the last bar on the chart or a specified ending bar as determined by the rules that dictate when a profile unit becomes invalidated, as discussed below.

At any point in time, an instance of the present invention may include a display revealing multiple valid profile units, each one beginning at its own pivot highs and lows.

In accordance with one embodiment of the present invention, each profile unit comprises an array of TPO's at each price from the lowest price of the profile dataset to the highest price of the dataset. Further, each profile unit can consist of three price areas determined by the following method:
1. Calculate the total number of TPOs in the array.
2. Calculate the number of TPOs in the “Value Area” according to a user-specified percentage parameter, which can be a percentage of the total number of TPOs. For example, if the user specifies “seventy” as the default percentage parameter, and if the total number of TPOs in a given dataset is one hundred, then the Value Area is defined as seventy TPOs. By the same calculation, the “Value Area Extreme High Price” is defined as (the number TPOs in the array)−(the number of TPOs in the Value Area) divided by two. In this example, 100−70=30. 30/2=15. Thus, the extreme high price is that price at which the fifteenth TPO occurs, counting down from the highest price in the dataset. The “Value area Extreme Low Price” is the price corresponding to the fifteenth TPO counting up from the lowest price in the dataset.
3. The price areas can now be delineated:
   a. Prices above the Extreme Value Area High Price (VAH).
   b. Prices below the Extreme Value Area Low Price (VAL).
   c. All other prices from the Value Area Extreme High Price down to the Value Area Extreme Low Price. This price area is the “Value Area”.

FIG. 6B illustrates the above method with twenty TPOs. As shown the chart 150 in FIG. 6B, there are twenty time-price opportunities (TPOs) or bars 152 in the given array. In calculating the number of TPOs in the value area, if one uses “seventy” as the percentage parameter, then the value area is defined as (20×0.70)=fourteen TPOs. Next the Value Area Extreme High Price can be calculated by the present invention as (20−14)/2=3. Thus, the extreme high price is that price at which the third highest TPO occurs, as shown at circular point 154 on the chart 150. The Value Area Extreme Low Price is the point of the third lowest TPO, as shown at circular point 156. As such, the VAH can be defined by line 158 and the VAL can be defined by line 160. The Value Area is the area 162 in between the VAH and the VAL.

It will be appreciated that another embodiment of the present invention employs volume at price instead of TPO's.

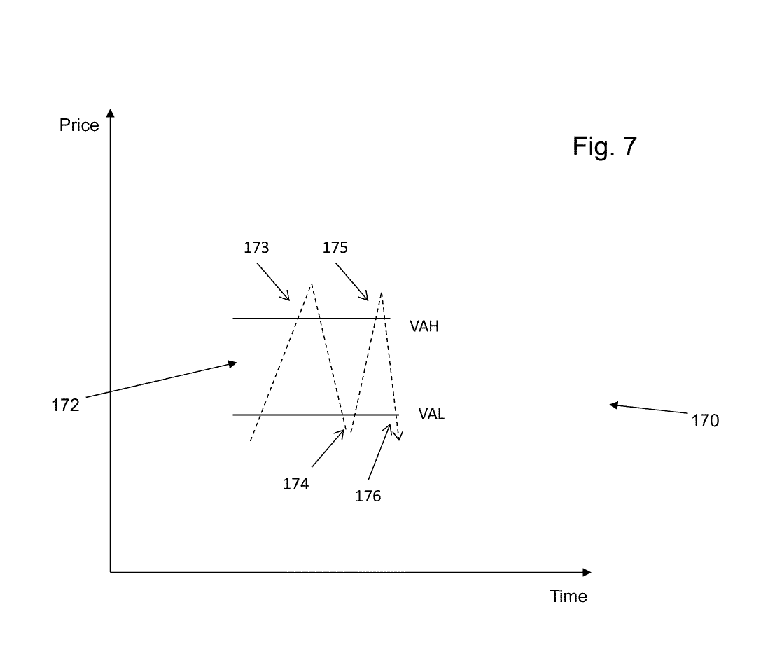

Next, the present invention assigns each profile unit a “Market Condition” value, which is a numerical value corresponding to the number of traversals through the value area. This numerical value is signed: a positive number indicates that the last traversal through the value area was from below the value area to above the value area; a negative number indicates that the last traversal was from above the value area to below the value area. The diagram 170 in FIG. 7 illustrates this, as each time price (illustrated in dashed lines) traverses the value area 172 (defined between VAH and VAL), its market condition is incremented. For instance, the market condition value at point 173 is +1, the market condition value at point 174 is −2, the market condition value at point 175 is +3 and the market condition value at point 176 is −4. The market condition is thus a numerical indication of the number of traversals through the value area. In one embodiment of the present invention, the market condition value is a signed integer, such that the last traversal can be immediately apparent, i.e., a positive integer denotes that the last traversal was from below the value area to above the value area and vice-versa.

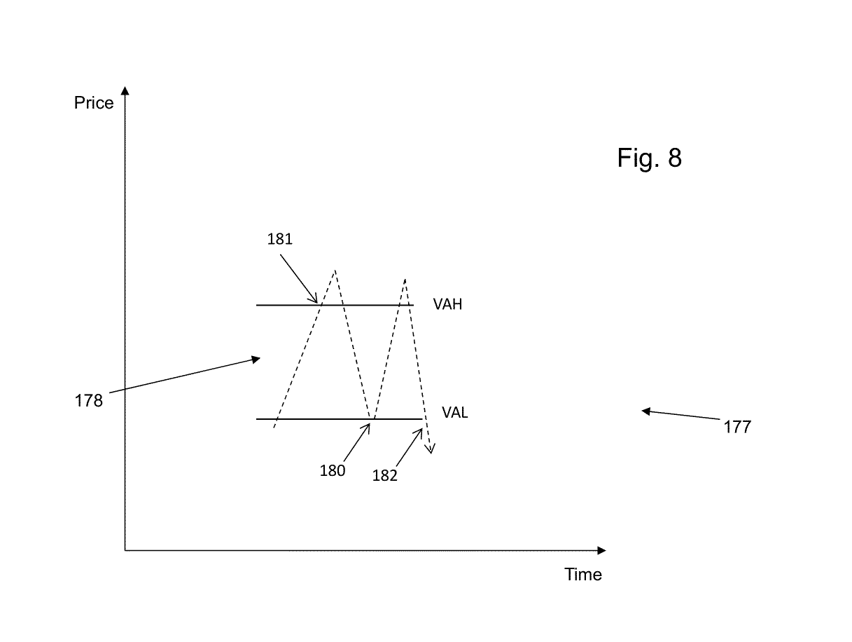

. It is important to note that the calculation of the value area in accordance with one embodiment of the present invention is performed anew each time a new bar is appended to the dataset. The assignment of market condition value is therefore recalculated with each new bar. In this manner, the market condition of a profile unit may decrease in absolute value as shown in FIG. 8. Whereas, in the diagram 170 of FIG. 7, the profile unit has a market condition of −4 at point 176, the diagram 177 of FIG. 8 depicts the same profile unit of FIG. 7 at a later point in time. In this example, price has continued to decline past point 176 of FIG. 7. In so doing, the recalculated value area 178 has moved down to a point such that the move down from the first advance at point 180 no longer penetrates the value area low (VAL). The newly-calculated market condition has now declined and has a current value of −2 as of the price reaching point 182. The market value variable had attained a value of +1 at point 181.

As described, the present invention thus creates profile units dynamically and assigns a numerical market condition value to each profile unit, wherein the market condition value also changes dynamically. The number of profile units created on a given price chart is determined by the strength of the swing point (i.e. pivot point) parameter. A swing strength of “one” will create a new profile unit each time a given bar has a higher high (or lower low) than the bar immediately to its left and an equal or greater high (or equal or lower low) than the bar immediately to its right. A swing strength of “three” will produce fewer swing points and thus fewer profile units: a given bar must now have a higher high (or lower low) than the three bars to its left, and an equal or greater high (or equal or lower low) than the three succeeding bars. As described above, the swing strength parameter can be established by a user of the present invention.

In addition, the present invention operates to categorize the profile units so that only the most relevant profile units are displayed, while invalidating and removing from the display any profile units that are no longer helpful. In this respect, the present invention reduces the number of calculations that it must perform as time elapses and as price bars (i.e., TPOs) are revealed.

Thus, the profile unit in accordance with the present invention is dynamic in that the starting point is determined by market activity: each profile unit begins at a swing point (i.e., pivot point). Further, while the calculation of the value area is constructed around a measure of central tendency, the operative starting point is the median as opposed to the mode (although other measures of central tendency can be employed). Further, the present invention explicitly uses rotations (traversals) through the value area as an integral part of the analysis in determining which profile units are displayed and which are ignored.

### Invalidation and Expiration of Profile Units

As referred to above, once a profile unit is created, the present invention will continue to “track” it until it has either been invalidated or become expired. A tracked profile unit can assist the user in discerning value areas that are helpful in anticipating price movements, whereas invalidated profile units are removed due to not being of significant value. In accordance with one embodiment of the present invention, the invention can “track” a profile unit by recalculating the value area on the addition of each new price bar, and/or recalculating the market condition based on the new boundaries of the value area.

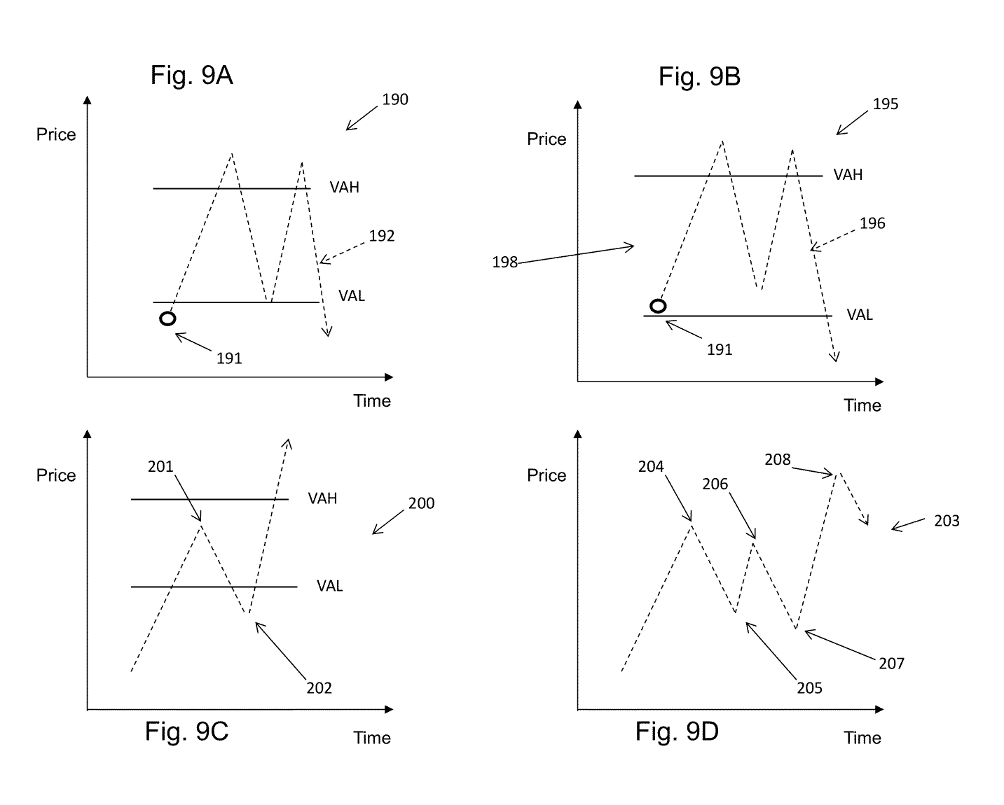

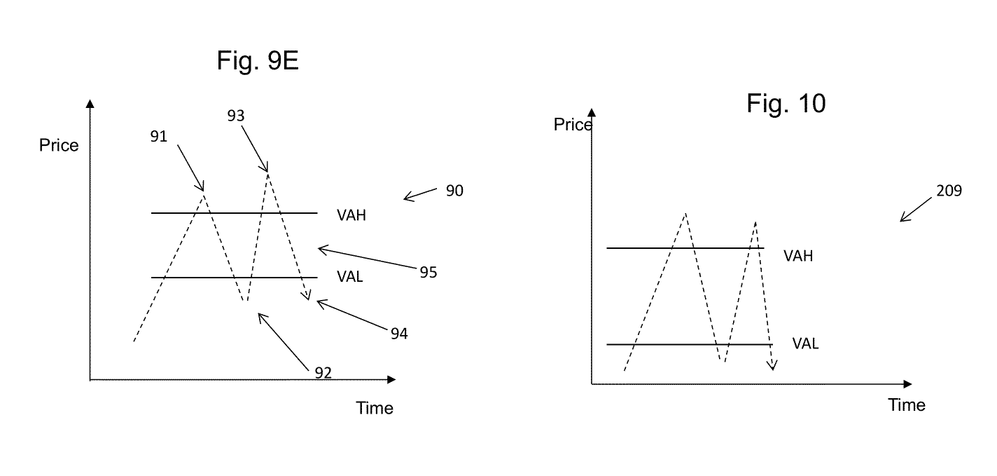

In one embodiment of the present invention, the invention invalidates profile unit only when its originating swing point is no longer within the extreme of the profile (i.e., when the originating swing point goes from being in an extreme area into the value area, based upon the continual re-calculations of the value area with each new price bar). For example, for a swing high, the profile unit is invalidated when the high point of that swing high is no longer above the High Extreme of the Value Area (VAH); or, for a swing low, the profile unit is invalidated when the low point of that swing low is no longer below the Low Extreme of the Value Area (VAL). An example of this is shown in FIG. 9A, where diagram 190 shows that swing point 191 begins a new profile unit. At the last bar 192 of this profile, the VAL is above the swing point. Swing Point 191 is thus a valid price extreme. By contrast, diagram 195 of FIG. 9B shows the same profile unit with the addition of new bars. Price has continued to move down as indicated by bar 196, and the value area low (VAL) has also moved down. At this point, Swing Point 191 is now within the recalculated value area 198 and thus is no longer an extreme low price by definition. As soon as point 191 is no longer below the VAL, the profile unit starting at point 191 becomes invalidated. In one embodiment of the present invention, once a profile unit is invalidated, it is deleted from further consideration and is no longer tracked.

In another embodiment of the present invention, the present invention invalidates a profile unit if its originating swing point disqualifies the profile unit from being the starting point of a balance by not being a valid “stopping price.” A valid ‘stopping price’ is a swing high or swing low that effectively ends a trend. As shown in the diagram 200 of FIG. 9C, the profile unit starting at swing point 201 is invalidated when the VAH rises to include the swing point. At the same time that profile unit starting at point 201 is invalidated, the profile unit starting at swing point 202 is also invalidated. Swing point 202 cannot be a valid stopping price because it occurs in the context of an uptrend. A valid “stopping price” effectively ends the prevailing trend. FIG. 9E shows a diagram 90 illustrating a sequence for a valid balance in connection with stopping prices. As shown in FIG. 9E, a stopping price is reached at price point 91, and a reaction swing occurs at point 92. A test of the stopping price occurs at point 93, and a test of the reaction swing occurs at 94. In this regard, it will be appreciated that a “stopping price” is not necessarily the highest high or lowest low within a balance. It is valid as long as its swing extreme is outside the value area, shown at 95, for example, in FIG. 9E.

When a prior swing high is invalidated by the first method described above, all subsequent swing lows that occur before the swing high that invalidates that profile unit are themselves invalidated at the same time. FIG. 9D provides examples of invalidation of profile units due to trend continuation. As shown in the diagram 203 of FIG. 9D, profile unit (not shown) associated with point 205 is invalidated when the swing down to point 207 occurs because price point 205 falls within the value area (not shown). The profile unit beginning at point 206 is invalidated at the same time as the profile unit starting at point 205 because profile unit starting at point 205 is invalidated. The profile unit starting at point 204 is invalidated when price point 294 falls within the value area of the profile unit starting at point 204. The profile unit starting at point 207 is invalidated at the same time as the profile unit starting at point 204 because the profile unit starting at point 204 is invalidated. Thus, the profile unit starting at point 208 is the only valid current profile unit to be displayed in accordance with this embodiment of the present invention.

By contrast, a profile becomes “expired” when the number of bars comprising that profile unit exceeds a predefined MaximumNumberOfBars parameter (e.g., established by a user) and its market condition has an absolute value of one. At this point, the profile is expired and is no longer tracked.

Determination of which are the Relevant Profile Units to Display

All Profile Units that have not been invalidated or expired will continue to be tracked with the addition of new price bars to the price chart. However, there are still potentially a large number of valid profiles, not all of which are relevant and many of which are redundant in that they add no valuable information to the user. In one aspect of the present invention, the system of the present invention assists in determining which profile units should be displayed on the price chart and which should not be displayed. In one embodiment of this aspect of the present invention, the market condition variable and the profile status variable are employed.

### Market Condition

A profile unit can be considered as balanced when the absolute value of its market condition is four or greater. This means that price has traversed through the value area at least four times. Balanced profile units may be displayed on the price chart providing they meet the additional criteria discussed hereinafter. Additionally, profile units with an absolute market condition value of three may also be displayed. These profiles can be called potential balances.

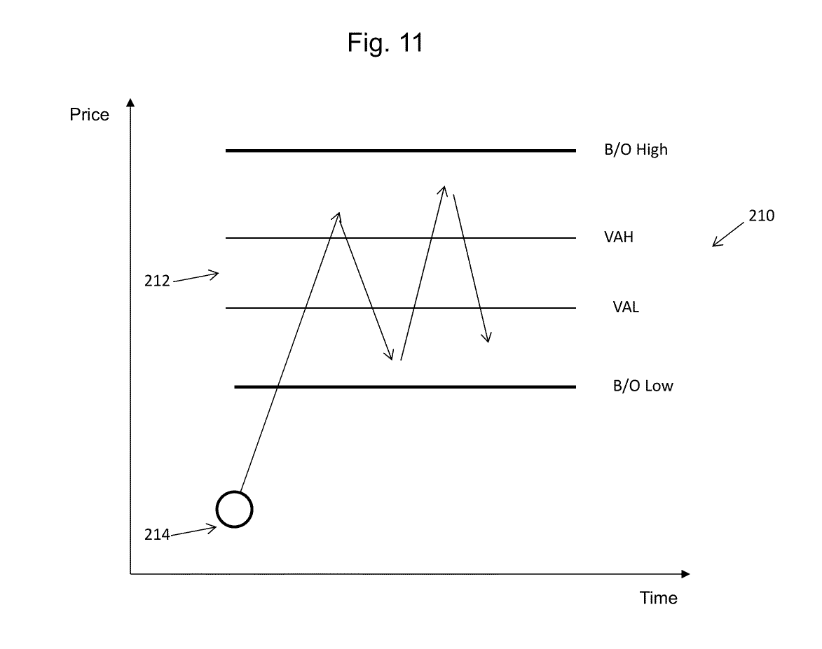

FIG. 10 shows a simplified exemplary diagram 209 of a balanced profile unit, assuming a market condition value of four. However, not all balanced profiles are displayed in accordance with one embodiment of the present invention. The value of the profile status in conjunction with the market condition can determine which balanced profiles are displayed on the price chart, in accordance with one embodiment of the present invention.

### Profile Status

The status of a profile unit can determine whether it is tracked (i.e., updated with the next price bar on the chart) and whether it is displayed. In one embodiment of the present invention, the profile status is a numerical signed integer value that can have the following values, for example:

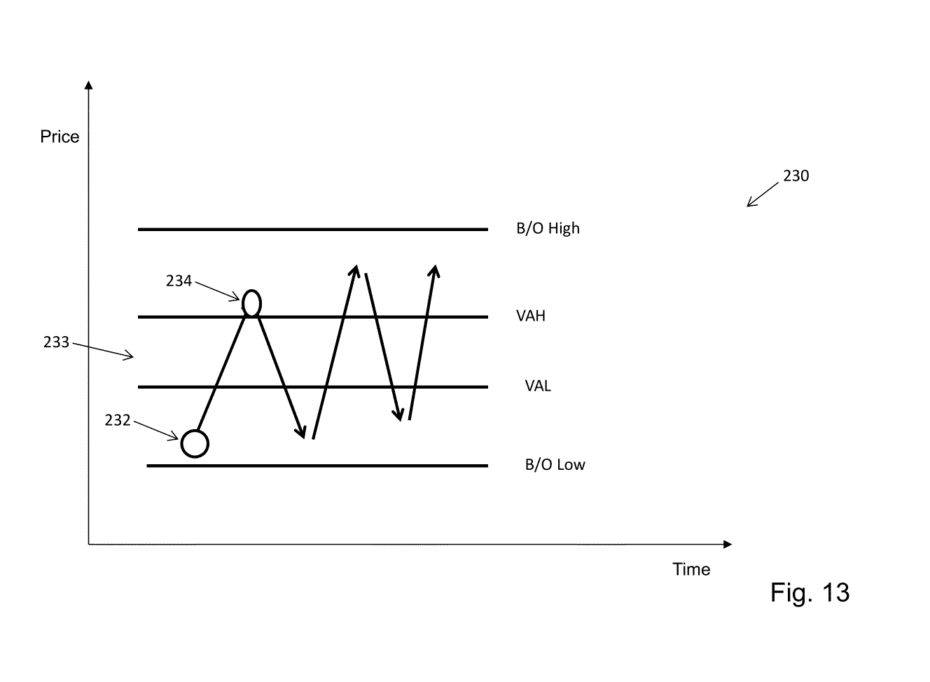

−2 This indicates that a Profile Unit has been invalidated because a prior profile unit has been invalidated with a Status of −1.
−1 A negative one status value indicates that the profile unit has been invalidated or expired.
0 A zero status value indicates that the profile unit is a new profile unit that the present invention has identified following the last completed price bar on the chart. This status value is temporary and tells the Profile management module of the present invention to assign a status.
1 A positive one value indicates a valid profile unit (i.e. it has not been invalidated or expired) that will continue to be tracked until it is invalidated or expired. It also indicates that the profile unit is not currently in balance (i.e. it has a market condition with an absolute value of less than 4, in the embodiment of the invention where market condition value of 4 is required for a profile unit to be considered in balance).
2 A positive 2 value indicates that the profile unit is in balance (it has a market condition with an absolute value of 4 or greater) and that it should be displayed on the price chart as a current active balance. Profile units with this status can be displayed in a particular color (e.g., yellow) on the chart, in one embodiment of the present invention.
3 A positive three value indicates that the profile Unit is a “potential balance” (it has a market condition with an absolute value of three). Profile units with this status can be displayed in a particular color (e.g. pale orange), in one embodiment of the present invention.
4 A positive four value indicates that a profile unit that has not been subsumed by an earlier profile unit has, or had, a market condition of balance, but that it does not currently meet the additional criteria for a valid balance. These additional criteria are discussed in detail below. If the profile unit previously met these criteria on an earlier bar on the chart, it may be displayed on the chart as a completed balance. Completed balances can be displayed in a different color from those in balance with a status of 2 (e.g., completed balances can be in a light blue or gray color—see below for a more detailed explanation).
5 A positive five value indicates that the profile unit has been “subsumed” by an earlier profile unit that is in balance. See FIG. 13 for an example of a subsumed profile unit and the description hereinafter.

### Valid Balances

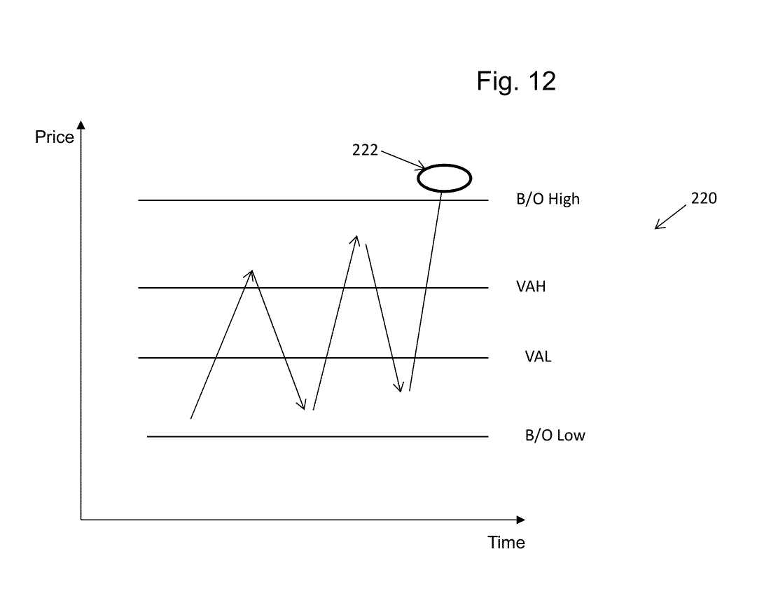

In one embodiment of the present invention, a profile unit is considered in balance when there have been a minimum of four traversals through its value area and it therefore has an absolute market condition of four or greater. Additionally, a profile Unit is considered a “Potential Balance” when it has an absolute market condition of three. Market condition is recalculated with the addition of each new bar on the chart. In addition, in one embodiment of the present invention, the profile unit must also satisfy each of the following conditions:
1. It must not be an ‘extreme balance’. An extreme balance is one in which the high and/or low of the balance is beyond the “break-out” price as described below. Once this test has been passed, it is not checked again. Diagram 210 in FIG. 11 shows an example of an extreme balance, which causes the status of the profile unit to change to four. In diagram 210, the profile unit has an absolute market condition value greater than three, based on the traversals through the value area 212. However, the low price of the Profile Unit (shown at position 214) is below the break-out low price (B/O Low). This is an “Extreme Balance” in accordance with one aspect of the present invention.
2. There must not have been a price break-out: after a balance has satisfied the first condition above, if the high or low of a new bar added to the profile unit is beyond the “break-out” price, the balance is no longer a valid current balance. The diagram 220 of FIG. 12 shows a break-out from balance. The first four swings in price are contained within the balance limits (B/O High and B/O Low). At point 222, price has moved above the high break-out line (B/O High).
3. It must not have been subsumed by an earlier starting balance, as described below.
4. The profile unit must not have been invalidated, as described above.
5. The absolute value of its market condition must not have reduced due to the addition of a new bar to the profile unit.

If all conditions are met, the profile unit has a status of two and will be displayed in a particular color (e.g., yellow) on the chart as an active current balance if its Market Condition has an absolute value of four or greater. A Profile Unit with an absolute market Condition of three has a status of three and can be displayed in a different particular color (e.g., pale orange) on the chart.

### Subsumption of Profiles

FIG. 13 shows a diagram 230 with two profile units in balance, based upon the exemplary standard of having a market condition value of at least four in order to qualify as a profile unit. The profile beginning at point 232 has a market condition value of five (five traversals through its value area 233). The profile beginning at point 234 has a market condition value of four (four traversals through its value area, ending above its value area). In the diagram, the value area for the profile beginning at point 234 is not shown, but one can imagine that its boundaries will be roughly similar to those of value area 233. Both profiles are in balance and their respective balances are both valid—they both meet all criteria that would assign them a profile status of two and, without the subsumption rule in accordance with the present invention, both profile units would both be displayed on the chart. It will be appreciated that displaying both profiles in this instance would not be desirable, especially when one considers that there may be even more profile units in a condition of balance. For instance, the chart can become too busy and may hinder the user's ability to discern valuable and potential trade locations. In this instance, the second profile unit is essentially “subsumed” within the first profile unit because (a) it starts later, (b) it covers the same price region, (c) its high price is above the VAH of the profile starting at point 232, and (d) it slow price is below the VAL of the profile starting at point 232.

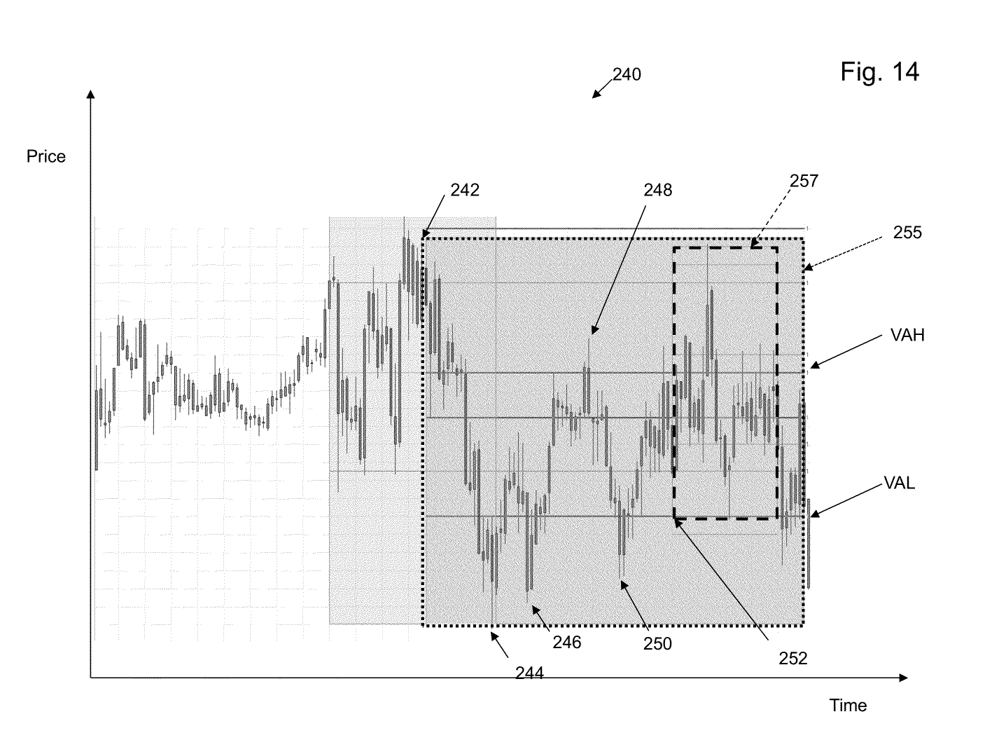

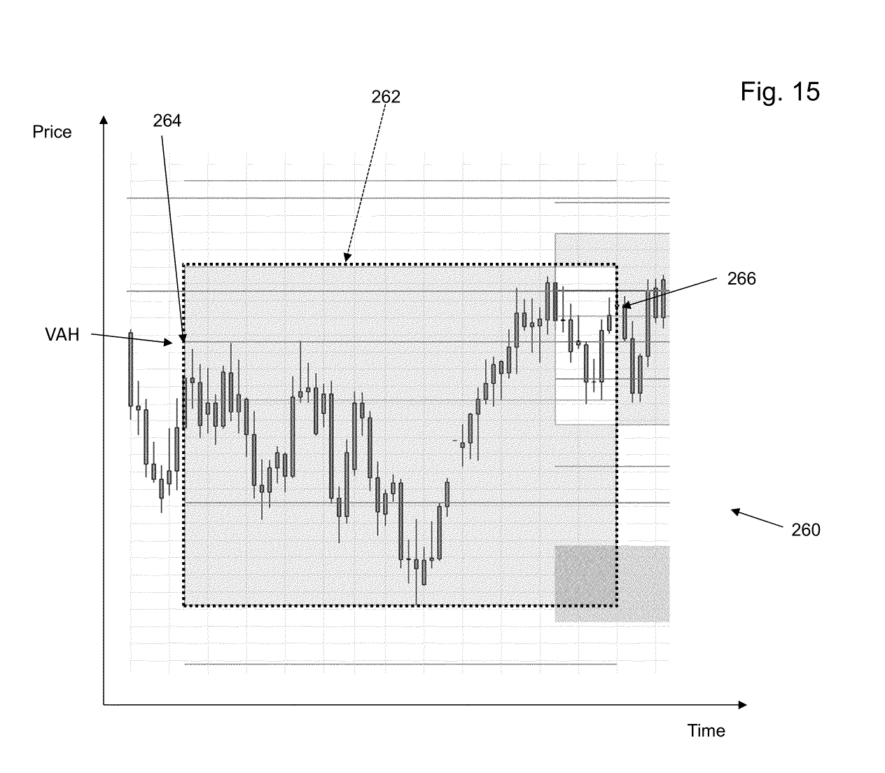

In FIG. 14, an exemplary display 240 of the present invention is shown. Six swing points are annotated on the chart, labeled 242, 244, 246, 248, 250 and 252. The profile unit 255 that begins at the swing point labeled 242 is displayed on the chart as an active current balance in dotted rectangular form. The profile unit 257 that begins at swing point 252 is also displayed on the chart, as a dashed rectangular form contained within profile unit 255. The profile units 255, 257 can be provided in color graphics in one embodiment of the present invention. Profile unit 257 is considered to be a completed balance because it ends before the latest completed bar on the chart.

The profile units that begin at swing points 244, 246, 248 and 250 are not displayed. All of these profiles have valid balance conditions, but if they were displayed the chart would contain four additional boxes and twenty additional lines, which would not be conducive to useful analysis. Thus, as each of these profiles is subsumed within the profile unit 2552, they are not displayed in display 240.

In one embodiment of the present invention, the subsumption rule of the present invention gives precedence to the earliest starting balance. In this example, it is the profile unit 255 starting at swing point 242. However, a later starting profile unit is only subsumed if the highest price within that unit is above the value area high (VAH) of the earlier profile unit and if the lowest price in the profile unit is below the value area low (VAL) of the earlier profile unit. The profile unit 257 starting at point 252 meets the first criterion, but not the second: its low is exactly equal to the VAL of profile unit 255. This is why profile unit 257 is also displayed on the chart 240 along with profile 255. The profile units starting at points 244, 246, 248 and 250 meet both criteria and are therefore subsumed within profile unit 255.

In an exemplary embodiment of the present invention, once a profile unit is subsumed, it remains subsumed until:
1. It is invalidated, in which case it will not re-appear and is no longer tracked.
2. The subsuming profile is itself invalidated, in which case the previously subsumed profile may be displayed, pending other factors described herein.
3. It has a market condition value of +1 or −1.
4. The subsuming profile is itself subsumed by an earlier profile unit.
5. The subsuming profile unit has a completed balance AND the subsumed profile does not meet one or more of the following criteria:
   a. The high of the subsumed profile unit is greater than the VAH of the completed balance of the subsuming profile unit.
   b. The low of the subsumed profile unit is less than the VAL of the completed balance of the subsuming profile unit.
   c. The high of the subsuming profile unit from its inception to the last bar of its balance is greater than the VAH of the subsumed profile unit.
   d. The low of the subsuming profile unit from its inception to the last bar of its completed balance is less than the VAL of the subsumed profile unit.

A subsumed profile unit will move to profile unit status five, which means that it will continue to be tracked as a valid profile unit, but will not be displayed even if it is an otherwise valid balance. In one embodiment of the present invention, it continues in this state until it is either invalidated itself, or its market condition is reduced to an absolute value of one, or until the status of the subsuming profile unit changes, at which point the subsuming profile unit “releases” the subsumed profile unit. If the subsuming profile unit (e.g. unit 255 in FIG. 14) is itself subsumed by an earlier starting profile unit, the subsumed profile unit (e.g., unit 257 in FIG. 14) may be plotted as a balance if it meets the balance criteria and is not itself subsumed by the second subsuming profile unit (i.e., the unit that subsumes profile unit 255 in this example), in one embodiment of the present invention.

### Determining the Endpoint of a Balance

As stated above, in one embodiment of the present invention, all profile units that have not been invalidated or expired continue to be tracked. This means that the addition of a new bar to the end of the price bar chart will cause each profile unit to be recalculated. Further, the value area for each profile unit will be updated based on the addition of the new bar and its market condition value will be recalculated based on the new limits of the value area.

With the addition of the latest bar, it will be appreciated that a profile unit that was in balance on the previous bar may now be out of balance. There are three possible causes of this:
1. The profile unit has been invalidated.
2. The absolute value of the market condition variable has declined, which can be called a “breaking balance.”
3. The latest bar has exceeded the break-out price of the balance.

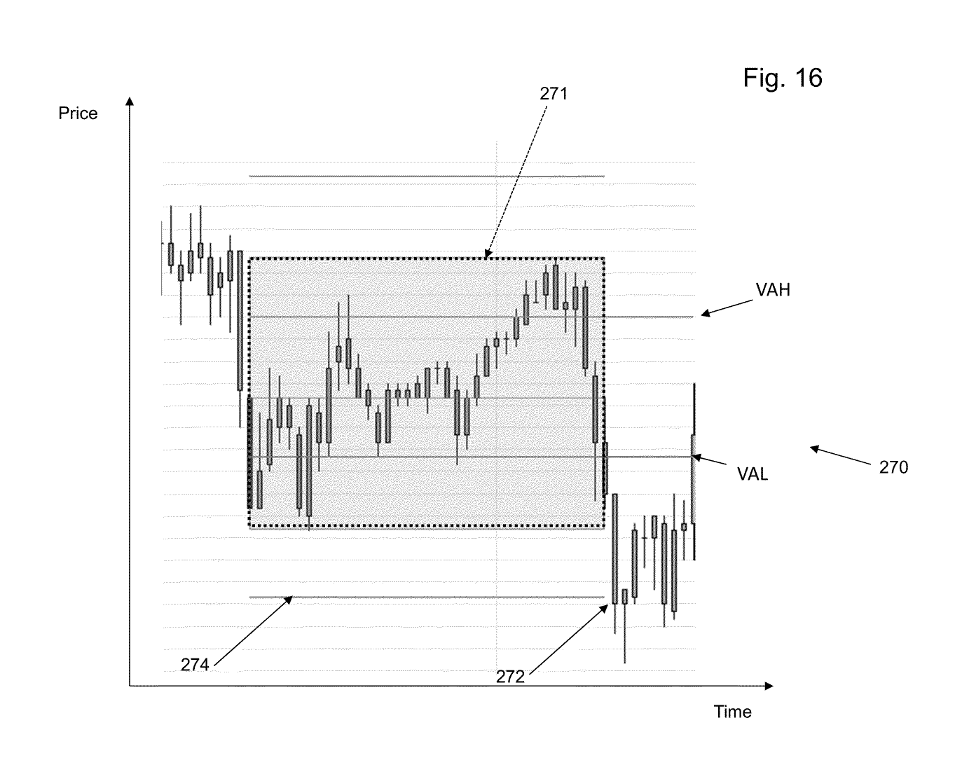

FIG. 15 shows an example display 260 of the present invention illustrating the ending of a balance due to invalidation of the profile unit 262. The starting high point 264 of profile unit 262 is found to be no longer an extreme price point after the addition of bar 266, as the high point 264 does not then exceed the Value Area High (VAH) of unit 262. FIG. 16 is an example display 270 of the present invention illustrating the end of a profile unit 271 due to a “break-out”. In this example, bar 272 exceeded the break-out price below the profile unit, indicated by the line 274. In one embodiment of the present invention, the break-out price is a user-configurable calculation based upon the size of the value area. The default configuration can be, for example, that the break-out price is one hundred percent (100%) of the value area (VAH−VAL) projected above the VAH and one hundred percent (100%) projected below the VAL. The upper break-out price is shown in the diagram as a solid green line above the blue balance box.

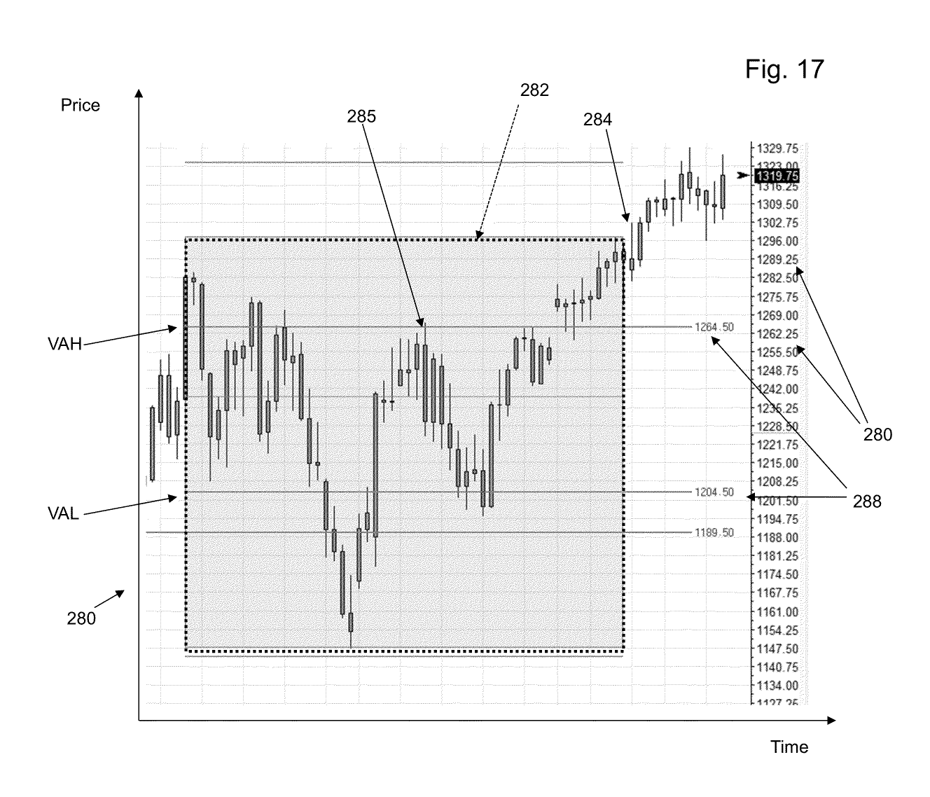

FIG. 17 shows an example display 280 in accordance with one embodiment of the present invention, showing a balanced profile unit 282 that ended because its market condition was reduced. This can be considered a “breaking balance” for purposes of the present invention. The addition of bar 284 to the profile unit 282 caused the VAH to move up from the value shown on the chart (1264.50). Should this caused the high of the bar 285 to no longer be above the VAH, then the value of the market condition variable of this profile unit 282 would change. On the bar immediately preceding bar 284, the market condition variable has a value of four. After bar 284 is added, and assuming it causes the VAH to move above the high of bar 285, the market condition variable value would be reduced to two. Reduction of the market condition variable ends the balance, even though the break-out price has not been reached, in accordance with this embodiment of the present invention. It will be appreciated that the display 280 in FIG. 17 also shows price values (e.g., 286) on the right border, and price values (e.g., 288) associated with the VAH and VAL lines. Such a display of price values assists the user because the user can better assess the values of any trade opportunities as a result.

Once a profile unit that was in balance moves out of balance by one of the above methods, its profile status changes. In the case of a balance ending because the profile unit is invalidated, the status of the profile unit changes to −1. The profile unit will no longer be tracked as additional bars are added to the chart in accordance with one embodiment of the present invention. In the other two cases, in an exemplary embodiment, the balance is ended but the profile unit can still remain active and will continue to be tracked with the addition of new bars to the chart. In these cases, the profile status will change to 4.

In all cases, the completed balances may continue to be displayed on the chart. When a balance ends, a copy of the profile unit variables (as of the last bar that it was in balance with) is stored separately from the variables of the profile unit, which will continue to update with each additional bar unless the profile unit becomes invalidated. These variables include the start and end bars of the balance; the high and low prices of the balance; the VAH, VAL and point of control (POC) representing the price with the most TPO's); and the market condition of the balance. In one embodiment of the present invention, two additional variables can be recorded: (1) the break-out direction of the balance: recorded as +1 if the break-out was up, −1 if the break-out was down, and 0 if no break-out has occurred, which may be the case if the profile unit is invalidated or if the balance ended because its market condition was reduced; and (2) the balance status: this will be recorded as 0 if price has broken above both its high break-out price and its low break-out price; +1 if price has not yet broken both of these boundaries; and −1 if the balance is invalidated.

In one embodiment of the present invention, the balance status determines the display status of the balance, according to rules such as, for example: If the balance status is +1, the balance is displayed in a color, such as light blue; if the balance status is zero, the balance is displayed in a color or shade, such as gray, for example; if the balance status is −1, the balance is not displayed.

A completed balance can be invalidated and cease to display on the chart in three ways, in one embodiment of the present invention: (1) the profile unit that created the balance can move back into balance; (2) a later starting profile unit that starts between the start and end bars of the completed balance can move into balance; and (3) a profile unit that starts earlier than the first bar of the completed balance can move into balance. In case (3), the subsumption rule of the present invention can be applied, whereby earlier balances have priority over later balances. In one embodiment of the present invention, completed balances are subject to the same subsumption rules as active current balances. The subsumption rule can also apply in case (1): a completed balance is subsumed if the profile unit that created the balance moves back into balance. In this case, the starting point of the profile unit is the same as that of the completed balance. In Case (2), a different rule can apply such that priority is given to a current balance over a completed balance. When a balance is completed, but the profile unit is not invalidated, the profile unit has a status of four. In one embodiment of the present invention, the profile unit keeps this status until it either returns to balance or one or more of the following is true: (1) it has an absolute market condition value less than four and: (a) the VAH of the profile unit is greater than or equal to the high of the completed balance, or (b) the VAL of the profile unit is less than or equal to the low of the completed balance; (2) the absolute value of market condition is one; or (3) the profile unit is invalidated. If the profile unit is not invalidated, but either of the first two conditions is true, the profile status is changed back to one, in accordance with one embodiment of the present invention.

### Target Zones

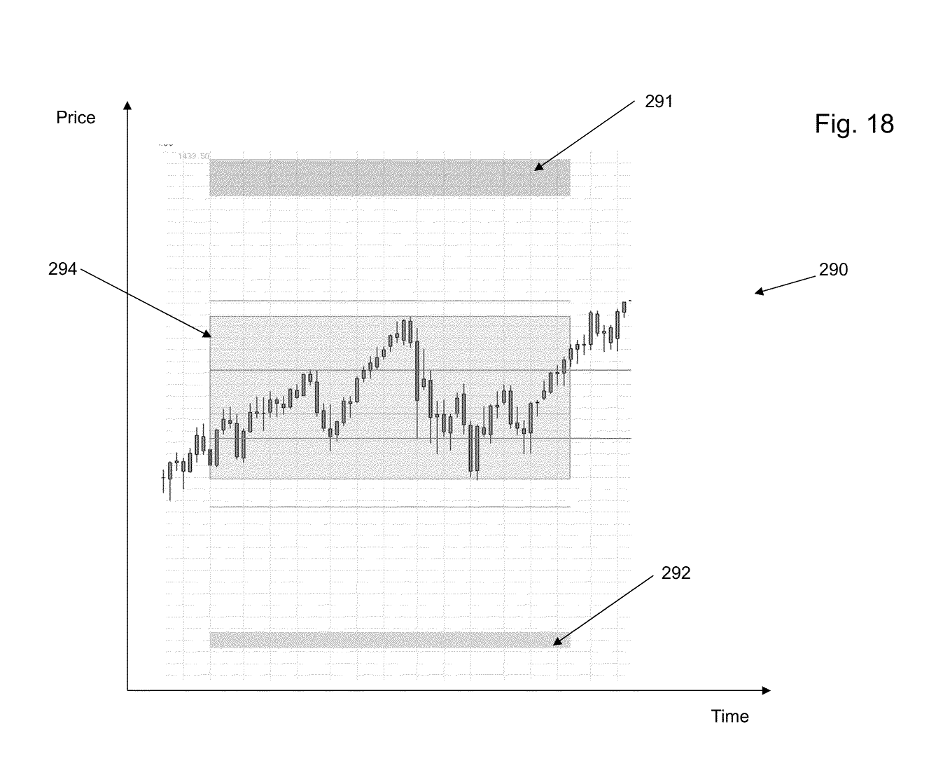

FIG. 18 shows upper 291 and lower 292 target zones on an example display 290 associated with the present invention. The calculation of these zones can be performed using an algorithm and/or formula based upon the characteristics of the balance area, for example. The upper target zone 291 is displayed above the balance area 294 and represents a target for an upside break-out of the balance area 294. The lower target zone 292 is displayed below the balance area 294, and represents the target for a downside break-out of the balance area 294.

In one embodiment of the present invention, there are two separate calculations for each zone, which provide the upper and lower boundaries of the zone. The elements of the calculations in accordance with one embodiment of the present invention are as follows:

“VAWidth” equals the width of the value area (VAH−VAL). “Balance width” equals High−Low. “VA_Density” equals (1−(VAWidth/Balance width)/(VA_Width/Balance Width). “POCpercent” equals TPOCount at POC/number of bars in balance (where POC is the point of control, or statistical mode of the price). “Skew adjustment” equals (High−POC)−(POC−((VA_Width/2)+VAL). “VA_Projection” equals VA_Width+((VA_Width*1.5)*VA_Density). “POC_Projection” equals VA_Width+(VA_Width*VA_Density)+(Skew_Adjustent*POCpercent). In one embodiment of the present invention, the two prices that define the upper target zone are: VAH+VA_Projection, and POC+POC_Projection.

In one embodiment of the present invention, the two prices that define the lower target zone are: VAL−VA_Projection and POC−POC_Projection.

The target zones provide traders with realistic price objectives for trades taken within the balance area. They can help traders define risk and reward of trades more effectively.

### Example Target Calculation

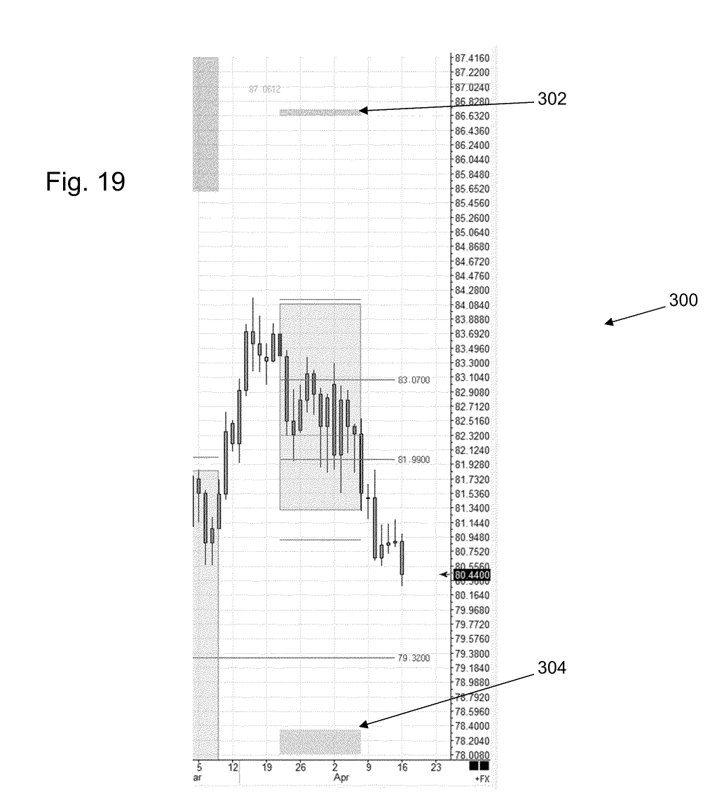

FIG. 19 shows an example display 300 with both upper and targets plotted. Using these example figures, the calculations are as follows:

$$1. VA Width = VAH ( 83.07 ) - VAL ( 81.99 ) = 1.08 \\ 2. Balance Width \text{:} High ( 84.09 ) - Low ( 81.30 ) = 2.79 \\ 3. \begin{matrix}VA\_Density = ( 1 - ( 1.08 / 2.79 ) ) / ( 1.08 / 2.79 ) \\ = ( 1 - 0.387 ) / 0.387 \\ = 0.613 / 0.387 \\ = 1.584\end{matrix} \\ 4. \begin{matrix}POC\_percent = \frac{TPOCount at POC ( 10 )}{No . of bars in profile ( 13 ) } \\ = 0.77\end{matrix} \\ 5. Skew Adjustment \text{:} ( High - POC ) - ( POC - ( ( VA Width / 2 ) + VAL ) ) = ( 84.09 - 82.32 ) - ( 82.32 - ( ( 1.08 / 2 ) + 81.99 ) ) = ( 1.77 ) - ( 82.32 - ( 0.54 + 81.99 ) ) ) = 1.77 - ( 82.32 - 82.53 ) = 1.77 - ( - 0.21 ) = 1.98$$

$$6. VA\_Projection \text{:} VA Width + ( ( VA Width * 1.5 ) * VADensity ) = 1.08 + ( ( 1.08 * 1.5 ) * 1.584 ) = 1.08 + ( 1.62 * 1.584 ) = 1.08 + 2.56 = 3.65$$

$$7. POC\_Projection \text{:} VAWidth + ( VAWidth * VADensity ) + ( Skew * POCpercent ) = 1.08 + ( 1.08 * 1.584 ) + ( 1.98 * 0.77 ) = 1.08 + 1 , 71 + 1.52 = 4.31$$

The upper projection 302 in FIG. 19 is thus:

VAH (83.07)+VA_Projection (3.65)=86.72

POC (82.32)+POC_Projection (4.31)=86.63
The lower projection 304 is:

VAL (81.99)−VA_Projection (3.65)=78.34

POC (82.32)−POC_Projection (4.31)=78.01

The elements of the calculations of the target zone in accordance with another embodiment of the present invention are as follows: (1) “Range” of the Balance area, which equals Profile High−Profile Low; (2) the median of the Value Area, i.e., the price of the fiftieth percentile of TPO's; (3) the Value Area High; and (4) the Value Area Low.

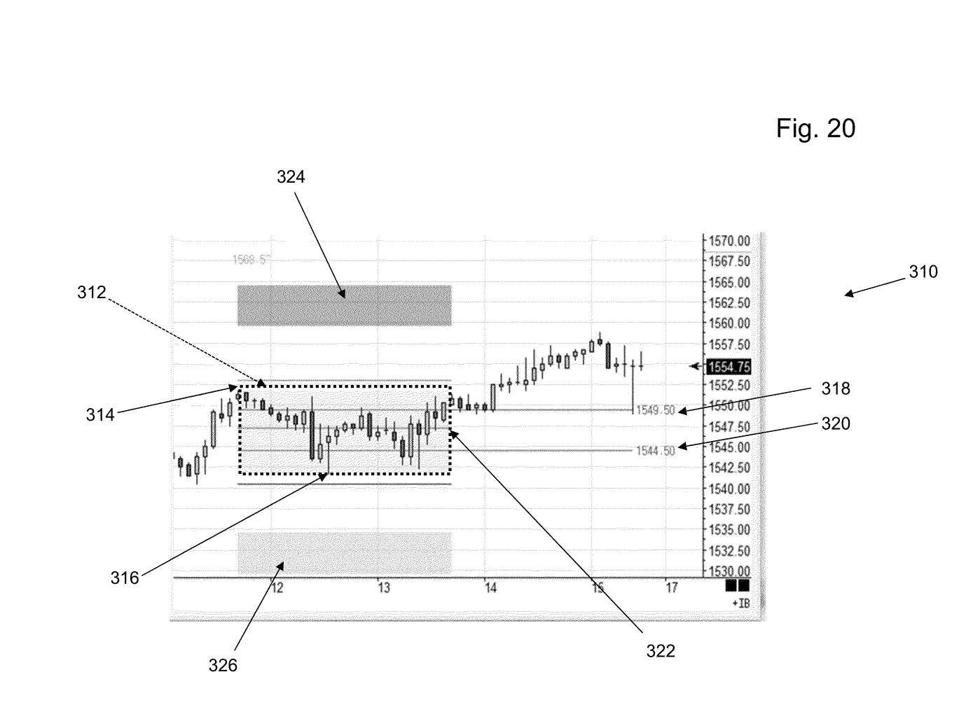

The calculations that follow use the example diagram 310 of FIG. 20 to illustrate the procedure using the balance shown at 312 (a completed balance). The data used in the calculation are as follows: Profile High: the highest high in the profile unit, shown at 314: 1551.75, Profile Low: the lowest low in the profile unit shown at 316: 1541.75, VAH: the Value area High: 1549.50 as indicated at 318, VAL: the Value area Low: 1544.50, as indicated at 320, Median: the price of the fiftieth percentile of TPO's: 1547.25, as indicated at 322.

The data above can be used to calculate the target zones above and below the balance as follows:
Calculate the Range: (Profile High−Profile Low)

1551.75−1541.75=10
Calculate the MedianHigh: VAH−Median

1549.50−1547.25=2.25
Calculate the MedianLow: Median−VAL

1547.25−1544.50=2.75

The Target Zone 324 above the balance is constructed from the following two data points:

1. Profile High+Range+MedianLow

1551.75+10+2.75=1564.50

2. Profile High+Range−MedianHigh

1551.75+10−2.25=1559.50

The Target Zone 326 below the balance is constructed from the following two data points:

1. Profile High−Range−MedianHigh

1541.75−10−2.25=1529.50

2. Profile High−Range+MedianLow

1541.75−10+2.75=1534.50

As shown and described above and in the drawings, the present invention can use TPOs and/or price bars for calculating the value area used in the present invention. However, it will be appreciated that a second embodiment of the present invention can use volume instead of TPOs. In such a case, the value area is calculated using volume at price, which may be calculated in real-time from transactional data or estimated from historical bars by assigning a portion of the bar volume to each price within the bar. The value area calculation is the same as for TPOs: the VAH and VAL are defined as user-defined percentile prices. The remaining calculations and determinations can be made as described above.

As will be appreciated, the present invention provides, in part, a method of using traversals through a value area as the method of determining balance. The present invention further uses rules as discussed above for determining which of the many profile units are relevant and should be displayed.

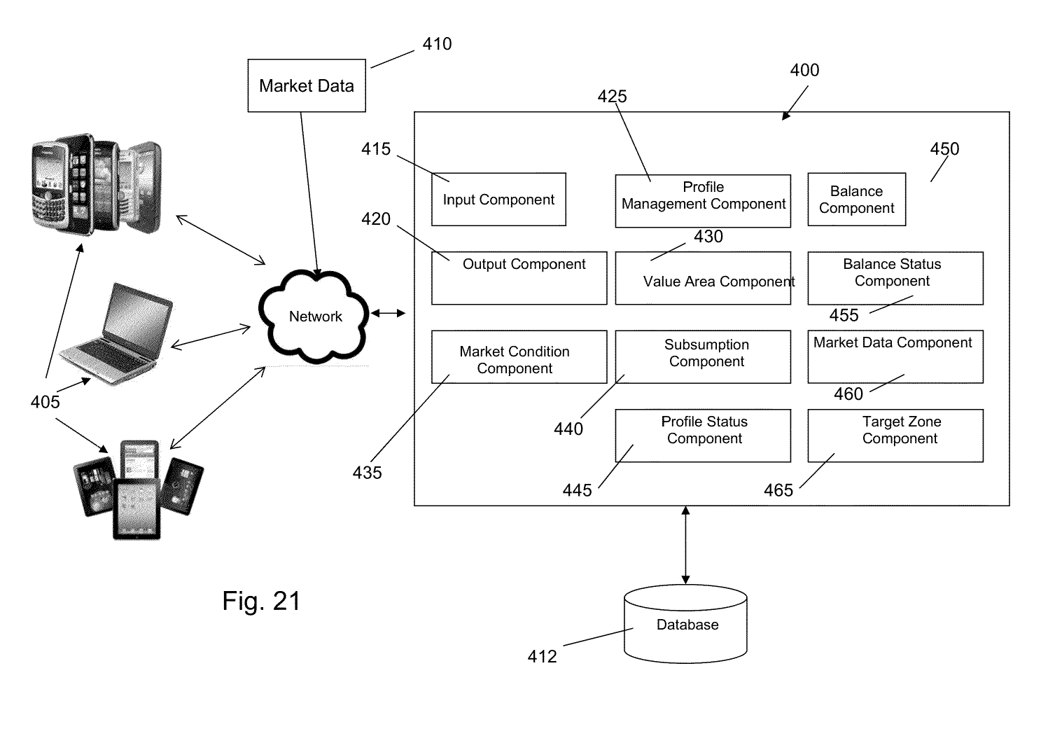

FIG. 21 also illustrates an exemplary high-level network with exemplary users and/or external computer systems that can interact with the system 400 of the present invention. The system 400 of the present invention can comprise various components capable of specific functions. The system is a computer-based system, where the components can be implemented in hardware, software, firmware, or combinations thereof.

As shown in FIG. 21, the users 405 can access the system 400 of the present invention through a network using client computing devices, such as desktop computers, laptop computers and mobile communication devices (MCDs), for example. It will be appreciated that the system of the present invention will incorporate necessary processing power and memory 412 for storing data and programming that can be employed by the processor to carry out the functions and communications necessary to facilitate the processes and functionalities described herein. Each of the client computing devices is configured to communicate with an application server (not shown) of the system 400. Appropriate encryption and other security methodologies can also be employed by the system of the present invention, as will be understood to one of ordinary skill in the art.

As further shown in FIG. 21, the system 400 of the present invention can incorporate various components for executing aspects of the present invention as described above, including an input component 415 for prompting a user for information, such as variable parameter information (e.g., variables such as minimum market condition values required for a profile unit to be in balance, percentage of TPOs to include in a value area, etc.). The input component 415 is adapted to receive information from users as well as from outside sources such as a provider of real-time market data 410, for example. The present invention can further include an output component 420 comprising software adapted to output information such as charts, graphs, instructions, menu selections and other output as appropriate in accordance with the description of the present invention herein. The present invention can further include a profile management component 425 comprising software adapted to make determinations, adjust, calculate, re-calculate and otherwise control information related to profile units as described herein.

The present invention can further include a value area component 430 comprising software adapted to determine value areas on a periodic basis as described herein.

The present invention can further include a market condition component 435 comprising software adapted to determine and/or calculate market condition values on a periodic basis as described herein.

The present invention can further include a subsumption component 440 comprising software adapted to determine when profile units are subsumed, and to track the subsumed profile unit to determine if it should be displayed and/or re-displayed in accordance with the present disclosure.

The present invention can further include a profile status component 445 comprising software adapted to determine and/or assign profile status values on a periodic basis as described herein.

The present invention can further include a balance component 450 and a balance status component 455 comprising software adapted to assess when a profile unit is in balance, and what value to assign to the balance status as described herein.

The present invention can further include a market data component 460 comprising software adapted to interact with one or more sources of market data (e.g., 410) in order to have part of the information required in order to operate the present invention.

The present invention can further include a target zone component 465 comprising software adapted to determine and/or calculate target zone values on a periodic basis as described herein.

It will be appreciated that the various components described are not necessarily exhaustive of all components that may be incorporated in order to carry out the functions, algorithms and calculations associated with the present invention. It will further be appreciated that the components interact with one another as necessary to carry out the functions, algorithms and calculations associated with the present invention. Thus, for example, the profile management component must communicate with the output component in order for newly determined balanced profiles to be presented for display.

The present invention operates, at least in part, to assist in the analysis of market price movement for a given tradable financial instrument, based on certain principles that are considered axiomatic:
1. The purpose of a market of any freely traded instrument is to facilitate trade. Trade is facilitated when the market price is perceived as being fair by both potential buyers and potential sellers. Transaction volume is maximized when this situation holds. It is therefore in the interests of the market owner (e.g. the CME or NYSE) to provide a transparent mechanism to allow buyers and sellers to discover prices that are perceived to be fair.
2. Price discovery through the dual “auction” process is the mechanism by which fair value is found. This is a continuous process: price moves up until it reaches a point which buyers consider too high, then moves down until unfair low prices are discovered. Once the boundaries of fair value are found, market participants can more confidently refine their estimates of what are considered fair prices at a particular time. The unfair price boundaries are continually tested to validate that the current perceptions of market value are still generally held. Inevitably, at some point, the general perception of market value changes and price moves to discover the next area of price agreement.
3. The continual search for, and validation of, fair prices results in two phases of market activity: market balance when buyers and sellers have found a general area of agreement of fair prices; and market imbalance or trend when perceptions of value have changed and the market is seeking a new range of prices that can be considered fair.
4. The market is fractal: the price discovery process operates on all timeframes all the time. This means that the same principles hold true whether one looks at a 5 minute bar chart or a weekly bar chart, for example.
   For a trader using the present invention, two more axioms may be added:
1. It is not possible to predict the direction of the next phase of imbalance.
2. A trader's “edge” is thus entirely dependent on executing trades at prices from which a greater than random price move may be expected to result. In general, favorable trade location is found at the extreme prices: the unfair highs and lows of a balanced market. At these extreme prices, the trader using the present invention can expect one of two events: either the price is still considered to be unfair, in which case price can be expected to move to the other extreme to validate that it too is still unfair; or, that the general consensus of fair value has changed and that price will move rapidly away from the balance area in search of new balance. Both events can result in a sharp move in price that is potentially much greater than the risk of a trade placed in anticipation of either event.

From the above, it can be seen that the present invention provides real-time information of value to a trader. The present invention highlights the areas of market balance and explicitly defines the prices which constitute the unfair highs and lows of the balance. These are the areas in which a trader using the present invention may choose to initiate trades as they represent good trade location with a favorable risk to reward ratio. Using the method according to the present invention, a trader does not have to correctly predict the market direction (which we maintain is not possible anyway) in order to profit: it is sufficient simply to execute a large number of trades with favorable location in order to have an “edge” in the market.

Unless otherwise stated, devices or components of the present invention that are in communication with each other do not need to be in continuous communication with each other. Further, devices or components in communication with other devices or components can communicate directly or indirectly through one or more intermediate devices, components or other intermediaries. Further, descriptions of embodiments of the present invention herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media. At a minimum, the memory includes at least one set of instructions that is either permanently or temporarily stored. The processor executes the instructions that are stored in order to process data. The set of instructions can include various instructions that perform a particular task or tasks. Such a set of instructions for performing a particular task can be characterized as a program, software program, software, engine, module, component, mechanism, or tool. Common forms of computer-readable media that may be used in the performance of the present invention include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions associated with the present invention to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, satellite, EDGE and EVDO, for example. Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present invention, as will be understood to one of ordinary skill in the art.

The present disclosure describes numerous embodiments of the present invention, and these embodiments are presented for illustrative purposes only. These embodiments are described in sufficient detail to enable those skilled in the art to practice the invention, and it will be appreciated that other embodiments may be employed and that structural, logical, software, electrical and other changes may be made without departing from the scope or spirit of the present invention. Accordingly, those skilled in the art will recognize that the present invention may be practiced with various modifications and alterations. Although particular features of the present invention can be described with reference to one or more particular embodiments or figures that form a part of the present disclosure, and in which are shown, by way of illustration, specific embodiments of the invention, it will be appreciated that such features are not limited to usage in the one or more particular embodiments or figures with reference to which they are described. The present disclosure is thus neither a literal description of all embodiments of the invention nor a listing of features of the invention that must be present in all embodiments.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, with programmed steps of the method of the invention for execution by a processing unit. Aspects of the present invention may be embodied in a computer program product, such as a diskette or other recording medium, for use with any suitable data processing system. The present invention can further run on a variety of platforms, including Microsoft Windows™, Linux™, Sun Solaris™, HP/UX™, IBM AIX™ and Java compliant platforms, for example. Appropriate hardware, software and programming for carrying out computer instructions between the different elements and components of the present invention are provided.

The invention may be embodied in other specific forms without departing from the spirit or essential characteristics thereof. The present embodiments are therefore to be considered in all respects as illustrative and not restrictive, and not limited by the foregoing description. Any and all changes which come within the meaning and range of equivalency of the invention described herein are therefore intended to be embraced therein.

1. A system, comprising:
a memory device having executable instructions stored therein; and
at least one processing device, in response to the executable instructions, operative to:
provide a graphical user interface display in the form of a price chart;
receive first input from a user establishing a plurality of parameters for determining in connection with the chart at least one of: a value area, a market condition, and an expiring profile unit;
receive second input, associated with at least one tradable financial instrument, from a market data component;
based on the received first and second input, determine whether at least one profile unit is to be displayed as part of the displayed price chart;
receive third input, associated with the at least one tradable financial instrument, from the market data component; and
based upon the third input, determining whether the at least one profile unit is to continue being displayed as part of the displayed price chart.

2. The system of claim 1 wherein the determination of whether at least one profile unit is to be displayed includes determining at least one value area on the chart, determining at least one pivot point on the chart, determining a representation for the at least one profile unit on the chart, and determining a market condition value associated with the at least one profile unit.

3. The system of claim 1 wherein the determination of whether at least one profile unit is to be displayed includes a determination of whether the at least one profile unit has been invalidated, subsumed or expired.

4. The system of claim 1 wherein the determination of whether at least one profile unit is to be displayed includes a determination of whether the at least one profile unit has been previously subsumed but is no longer subsumed and is not invalidated or expired.

5. The system of claim 1 wherein the third input is new price information for the given tradable financial instrument.

6. The system of claim 2 wherein the at least one value area is re-determined upon receipt of the third input, and further wherein the market value is re-determined based on the re-determined at least one value area.

7. The system of claim 1 wherein the instructions further determine whether the at least one profile unit is balanced.

8. The system of claim 7 wherein the instructions further determine a profile unit status for the at least one profile unit, wherein the status is at least one of: invalidated, expired, subsumed, paused, breaking balance or extreme balance.

9. The system of claim 8 wherein determining whether the at least one profile unit is to continue being displayed includes determining not to continue displaying the at least one profile unit upon the profile unit status being determined as one of: invalidated, expired, subsumed, paused, breaking balance or extreme balance.

10. The system of claim 1 wherein the first input comprises a designated break-out price or break-out price parameter.

11. The system of claim 1 wherein the instructions further cause the display on the chart of at least one past, complete profile unit and at least one current, balanced profile unit.

12. The system of claim 1 wherein the instructions further determine whether the at least one profile unit has a completed balance, a break out direction and a balance status.

13. The system of claim 1 wherein the instructions further cause the display on the chart of at least one profile unit formerly having a completed balance as a currently balanced profile unit based upon the profile unit moving back into balance based upon the third input.

14. The system of claim 1 wherein the instructions further determine at least one target zone, and display the at least one target zone as part of the display.

15. A computer-implemented method, comprising:
presenting a graphical user interface display in the form of a price chart;
receiving first input from a user establishing a plurality of parameters for determining in connection with the chart at least one of: a value area, a market condition, and an expiring profile unit;
receiving second input, associated with at least one tradable financial instrument, from a market data component;
based on the received first and second input, determining whether at least one profile unit is to be displayed as part of the displayed price chart;
receiving third input, associated with the at least one tradable financial instrument, from the market data component; and
based upon the third input, determining whether the at least one profile unit is to continue being displayed as part of the displayed price chart.

16. A computer-implemented method for presenting a price chart for a tradable financial instrument, comprising:
providing a graphical user interface display;
receiving market data associated with at least one tradable financial instrument;
presenting a price chart on the display;
determining a position for displaying at least one profile unit as part of the price chart, with the profile unit comprising an area of perceived price balance for the at least one tradable financial instrument; and
determining at least an upper and a lower price target zone, and displaying the upper target zone as part of the price chart in a position above the at least one profile unit, and further displaying the lower price target zone as part of the price chart in a position below the at least one profile unit.

17. The method of claim 16 wherein the at least one profile unit is substantially rectangular in shape.

18. The method of claim 16 including the further step of determining a price value area for the at least one tradable instrument, and displaying the value area as part of the price chart.

19. The method of claim 16 including the step of determining a position for at least one additional profile unit, and displaying the at least one additional profile unit as part of the price chart.

20. The method of claim 19 including the step of removing the at least one profile unit from the display of the price chart.
